(19) United States
(12) Patent Application Publication
(10) Pub. No.: US 2025/0086629 A1
(43) Pub. Date: Mar. 13, 2025

(54) SYSTEMS AND METHODS FOR DISTRIBUTING NETWORK SERVICES

(71) Applicant: MASTERCARD INTERNATIONAL INCORPORATED, PURCHASE, NY (US)

(72) Inventors: Saranya Hemanthkumar, London (GB); Hélène Van Puyvelde, Namur (BE); Vijila Sudhakar, O'Fallon, MO (US); Sergey Dementiev, Moscow (RU); Mikhail Agafonov, Istanbul (TR); Natalya Filatieva, Dubai (AE); Kedar Thakur, Dubai (AE)

(21) Appl. No.: 18/666,707

(22) Filed: May 16, 2024

(30) Foreign Application Priority Data
Sep. 7, 2023 (RU) 2023123241

(51) Int. Cl. G06Q 20/40

(52) U.S. Cl. CPC G06Q 20/401

(57) ABSTRACT

Systems and methods are provided for use in integrating one or more value added service(s) associated with network messaging into a domestic processing network. One example computer-implemented method includes receiving, from a domestic processing network, an authorization message for a transaction to an account. The authorization message includes a first identifier associated with a first institution, a second identifier associated with a second institution, and a switch identifier. The method also includes identifying the transaction as a domestic transaction in a first region, based on the first identifier, the second identifier and/or the switch identifier included in the authorization message, and performing at least one value added service for the transaction, without seeking authorization of the transaction. The method then includes returning a result of the at least one value added service to the domestic processing network.

### CROSS-REFERENCE TO RELATED APPLICATION

This application claims the benefit of, and priority to, Russian Patent Application No. 2023123241, filed on Sep. 7, 2023. The entire disclosure of the above-referenced application is incorporated herein by reference.

### FIELD

The present disclosure generally relates to systems and methods for distributing network services (e.g., value added services, etc.) to switching networks in restricted regions.

### BACKGROUND

This section provides background information related to the present disclosure which is not necessarily prior art.

Networks are known to provide various services, depending, for example, on types of the networks. In connection with payment networks, for instance, the networks coordinate messaging between different institutions to facilitate payment account transactions, whereby the networks provide switching of messaging related to the specific transactions. The messaging may be local to given regions, or the messaging may be between multiple different regions.

### BRIEF DESCRIPTION OF DRAWINGS

The drawings described herein are for illustrative purposes only of selected embodiments and not all possible implementations, and are not intended to limit the scope of the present disclosure.

FIG. 1 is a block diagram of an example system of the present disclosure suitable for use in integrating one or more value added service(s) with regional network switching;

FIG. 2 is a block diagram of an example computing device that may be used in the system of FIG. 1; and

FIG. 3 is an example method, which may be implemented in connection with the system of FIG. 1, for use in integrating one or more value added service(s) associated with network messaging into a domestic processing network.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

In connection with network messaging (e.g., associated with payment transactions, etc.), networks layer on one or more value added service(s) to aid in performance of the network and/or to augment the service(s) applied by the network. In payment networks, the one or more value added services may include fraud scoring, dispute management, etc., for example. In instances in which a region requires in-region or on-soil switching in the region in processing transactions, or other region-specific limitations, the one or more valued added services may be restricted from being applied in the region, unless the value added services are reproduced and/or located on-soil in the region.

Uniquely, the systems and methods herein integrate one or more value added services hosted outside the restricted region into on-soil network services within the region (or domestic to the region). In particular, in connection with a transaction domestic to a first region, a domestic processing network (in the region) forwards the authorization request to an external processing network located outside of the region. The external processing network identifies the transaction as domestic to that region, performs one or more values added services and returns a result. The domestic processing network then proceeds to authorize the transaction, whether based on the result from the external processing network or not, in the region, i.e., effects domestic switching of the transaction therein. Clearing and settlement of the transaction may further be performed in the first region, in whole or in part.

In this manner, advanced value added service(s), which are offered by the external processing network, are made available to domestic transactions in the first region despite certain aspects of the transaction being preserved domestically (e.g., via on-soil rules, regulations, etc.), without requiring physical presence of the service in the first/domestic region. This is a technical advancement of the domestic and external processing networks, while the same is generally transparent to involved institutions, merchant, etc.

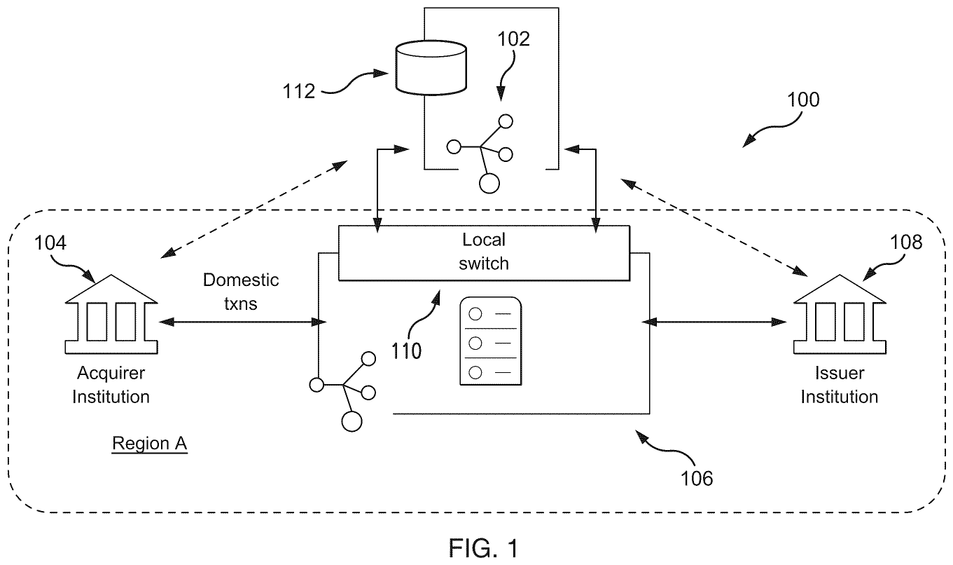

FIG. 1 illustrates an example system 100 in which the one or more aspects of the present disclosure may be implemented. Although the system 100 is presented in one arrangement, other embodiments may include the parts of the system 100 (or other parts) arranged otherwise depending on, for example, integration therebetween, types of value added services available/implemented, rules and regulations regarding regional restrictions on transactions, etc.

The illustrated system 100 generally includes an external processing network 102, an acquirer institution (or acquirer) 104 associated with a first party (not shown), a domestic processing network 106, and an issuer institution (or issuer) 108, each coupled to (and in communication with) one or more networks, indicated by the arrowed lines. The network(s) may include, without limitation, a wired and/or wireless network, a local area network (LAN), a wide area network (WAN) (e.g., the Internet, etc.), a mobile network, and/or another suitable public and/or private network capable of supporting communication among two or more of the illustrated parts of the system 100, or any combination thereof. In one embodiment, the networks include different networks accessible to different ones of the illustrated parts in FIG. 1. For instance, the networks may include a private payment transaction network made accessible by the domestic processing network 106 to the acquirer institution 104 and the issuer institution 108 and, separately, a public network such as the Internet through which the domestic processing network 106 and the external processing network 102 may communicate.

The acquirer institution 104 is a financial institution, such as, for example, a bank, which is configured to issue accounts to parties and to participate in payment account transactions involving the issued accounts. For example, the acquirer institution 104 may be configured to issue an account to the first party, which may be a merchant or service provider, and then to participate in payment account transactions between the first party and a customer thereof, etc.

Similarly, the issuer institution 108 is a financial institution, such as, for example, a bank, which is configured to issue accounts to customers (e.g., purchasers, etc.) and to participate in payment account transactions involving the issued accounts. For example, the issuer institution 108 may be configured to issue an account to a person, which is a customer, and then to authorize payment account transactions between the customer and a merchant, etc. The authorization may be based on the available funds or credit associated with the issued account, standing of the account, controls/rules, authentication, fraud scoring, etc.

The domestic processing network 106 is a payment processing network, in this example, which is configured to coordinates switching of transactions between the acquirer institution 104 and the issuer institution 108 and similar like institutions. It should be appreciated that an institution in communication with the domestic processing network 106 may be the acquirer institution 104 for one transaction, and then the issuer institution 108 for another transaction. In connection with the above, the domestic processing network 106 is configured to authorize, clear and settle transactions.

In particular, the domestic processing network 106 is configured to receive authorization messages from the acquirer institution 104, where the authorization messages are authorization requests that may each include, for a given transaction, an account number for a funding account, an account number for a recipient account, an amount, a name of the first party associated with the transaction (i.e., the recipient), an identifier associated with the acquirer institution 104 (e.g., an acquirer ID, etc.), a data/time, currency, etc., and other suitable data indicative of the transaction or the parties thereto.

Next, the domestic processing network 106 is configured to identify the issuer institution 108, in this example, (e.g., based on the account number of the funding account, etc.) and to forward the corresponding authorization messages to the identified issuer institution 108. The issuer institution 108, in turn, is configured to assess the transactions (e.g., based on the data included in the received authorization messages, etc.) and to approve or decline the transactions. In either instance, the issuer institution 108 is configured to compile and transmit authorization messages back to the processing network 106, where the authorization messages each include an authorization reply responsive to the authorization request of the received message.

The domestic processing network 106 is configured to then forward the authorization messages (received from the issuer institution 108) to the appropriate acquirer institution 104, which, in turn, notifies the first party of the disposition.

Further, as necessary, the acquirer institution 104 and the issuer institution 108 are configured to cooperate, through the domestic processing network 106, to clear and settle the transactions (generally, in combination with hundreds, thousands, or more other transactions, etc.).

It should be understood that the above example is related to domestic transactions, with reference to Region A, for instance, as defined by the dotted line in FIG. 1. Region A may be defined as a country, territory, province, state, postal code, or other geo-political and/or natural boundary, etc. As such, the acquirer institution 104 and the issuer institution 108 are each located in and domestic to Region A. Likewise, the domestic processing network 106 is located at least in Region A (and may extend to other regions). In some situations, Region A may be governed by one or more regulations or rules, which require the domestic processing network 106 to be located at least partially in Region A and to domestically “switch” the transactions which originate from in Region A (e.g., from acquirer institution 104, etc.) and/or are directed to an institution in Region A (e.g., to issuer institution 108, etc.), or more generally transactions within Region A. For purposes of the description herein, the domestic processing network 106 is domestic to Region A.

In contrast, the external processing network 102 is located outside of Region A. Consequently, for the above one or more regulations and rules applicable to Region A, the external processing network 102 is not permitted to switch transactions, which originate from in Region A (e.g., from the acquirer institution 104, etc.) and/or are directed to an institution in Region A (e.g., to the issuer institution 108, etc.), or more generally domestic transactions within Region A. This may be applicable, in various embodiments, where the region is a country, and that country imposes the one or more regulations and/or rules.

Apart from the rules and regulations, it should be understood that the external processing network 102 is configured consistent with the domestic processing network 106 to authorize, clear and settle transactions. The transactions may include transactions that originate in Region A (but are directed outside of Region A) or may include transactions that are directed to Region A (but originate outside of Region A), generally, international transactions or cross-border transactions, as it relates to Region A. As such, the external processing network 102 is configured to communicate with the domestic processing network 106, for example, through a local switch 110 in Region A. The local switch 110 is part of the domestic processing network 106, and the local switch 110 is configured to receive and transmit messaging to/from the external processing network 102 for transactions associated with Region A. That said, it should be understood, then, that the external processing network 102 does not include infrastructure or hardware to process, or more specifically, authorize, clear or settle the transactions domestically in Region A.

In addition, the external processing network 102 includes value added services 112, which may be applied to transactions processed through the external processing network 102. The value added services 112 may include, without limitation, fraud scoring, catastrophic fraud prevention/rules, loyalty services, authentication services, analytics services, dispute management services, exposure monitoring, etc. For example, the external processing network 102 may be configured to generate a fraud score for a transaction, based on one or more models, rules, logics, etc. that identify the transaction as eligible for (or subject to) the fraud scoring service, and append the resulting fraud score to the messaging directed to the issuer institution 108 (e.g., an authorization request message, etc.), whereby the issuer institution 108 is configured to rely on the fraud score in deciding to approve or decline the transaction.

In this example embodiment, as it relates to processing a transaction by the domestic processing network 106 and the external processing network 102, the acquirer institution 104 is generally configured to direct authorization messaging to the processing network indicated by the account number included in the authorization messaging. For example, a bank identification number or BIN is included in an account number to indicate the specific processing network to process the transaction (for which the account number is provided for funding).

In this example, due to the rules and regulations in Region A, when a transaction is domestic in Region A, the external processing network 102 is not permitted to authorize the transaction, and also, potentially, not permitted to clear or settle the transaction (e.g., depending how the region defines “processing” or “switching” the transaction, etc.). For domestic transactions in Region A, the external processing network 102 elects or designates the domestic processing network 106 to authorize and potentially clear and settle the transaction.

Consequently, the acquirer institution 104 is configured to identify the domestic processing network 106 (e.g., based on the BIN or other portion of the transaction account number in the authorization messaging, etc.) (e.g., based on BIN routing tables herein, etc.) and to direct the authorization message for the transaction to the domestic processing network 106. In this manner, for example, based on the BIN routing tables, the acquirer 104 is configured to identify the domestic processing network 106 and direct the message accordingly, even when the BIN is associated with the external processing network 102.

In turn, in this example embodiment, the domestic processing network 106 is configured to process the transaction. As part thereof, uniquely, the domestic processing network 106 is configured to direct the authorization message for the transaction, in whole or in part, to the external processing network 102. Specifically, the domestic processing network 106 is configured to identify the transaction as domestic and/or identify the external processing network 102 for value added services based on, for example, the account number (or BIN thereof) and associated country code, acquirer identifier (e.g., acquirer ICA, etc.), transaction type, and transaction currency and/or other data indicative of the transaction being domestic, or not, etc. The domestic processing network 106 is configured to then submit the authorization messaging to the local switch 110 of the external processing network 102 included in Region A, in a defined format, such as, for example, based on the ISO 8583 standard format, etc.

It should be understood that the authorization message may be transmitted to the external processing network 102 in one or more other manners, through the local switch 110 (e.g., consistent with an ISO 2022 standard, an ISO 8583 standard, etc.) or apart from the local switch 110, such as, for example, through an application programming interface (API), a payment gateway, etc.

The external processing network 102 is configured to receive the authorization message from the domestic processing network 106, generally, in the same manner as other messages from the acquirer institution 104, the issuer institution 108 and other institutions. The external processing network 102 is configured to then identify the transaction as a domestic transaction in Region A. Specifically, the external processing network 102 is configured to identify the account number (or BIN thereof) as associated with an institution in Region A (i.e., the issuer institution 108), a currency of the transaction as being specific to Region A, an acquirer identifier or ID being specific to an institution in Region A (i.e., the acquirer institution 104), and the switch identifier or ID of the local switch 110 as being located in Region A. Based on this data, the external processing network 102 is then configured to further identify that the transaction included in (or represented by) the authorization message is governed by the relevant rules and regulations for Region A.

In response, the external processing network 102 is configured to apply one or more of the value added services 112 to the authorization request, as understood between the external processing network 102 and the processing network 106.

For example, the external processing network 102 may be configured to generate a fraud score for the transaction and to return the fraud score to the domestic processing network 106, via the switch 110. In another example, the external processing network 102 may be configured to log the transaction to a dispute management data structure and, potentially, to perform analysis related thereto. In yet another example, the external processing network 102 may be configured to create or update a loyalty profile for the customer initiating the transaction; and/or to perform analytics related to the transaction; and/or to verify a cryptogram associated with an enhanced authentication sequence (e.g., as defined by 3DS authentication standards, etc.). It should be appreciated that any suitable value added service, which is aimed to support or aid the transaction, customer, merchant, the domestic processing network 106, and/or institutions involved in the transaction may be applied through the value added services 112.

That said, in this example embodiment, the external processing network 102 is specifically configured, based on identifying the transaction as domestic in Region A, to omit pursuing authorization of the underlying transaction, which is different than what is conventional. As such, the external processing network 102 does not pass the authorization message to any issuer institution, or clear or settle the transaction in this example (e.g., the external processing network 102 only applies the one or more value added services to the transaction, etc.).

Subsequently, the external processing network 102 is configured to return a response to the domestic processing network 106, relating to the one or more value added services, etc. The response, in general, is specific to the one or more value added services, which were performed by the external processing network 102. In connection with the domestic processing network 106 forwarding the authorization message to the external processing network 102 (as described above), the domestic processing network 106 is further configured to wait for a response therefrom (e.g., before proceeding further, etc.). In turn (e.g., based on (or in response to) the response from the external processing network 102, etc.), the domestic processing network 106 is configured to forward the authorization message to the issuer institution 108, in this example, and potentially, to append data to the authorization message based on the response from the external processing network 102. In one example, the domestic processing network 106 (or the external processing network 102 directly) is configured to append a fraud score to the authorization message prior to forwarding the same to the issuer institution 108 (based on the response from the external processing network 102, etc.).

In response, as above, the issuer institution 108 is configured to assess the transaction (e.g., based on the data included in the authorization message, originally or as augmented by the response received from the external processing network 102, etc.) and to approve or decline the transaction. In either instance, the issuer institution 108 is configured to compile and transmit an authorization message to the processing network 106, where the authorization message includes an authorization reply, to the authorization request message. Upon receipt of the authorization reply, the domestic processing network 106 may, optionally, be configured to identify the transaction, again, as domestic and submit the authorization reply to the external processing network 102. As described above, the external processing network 102 is configured to perform the one or more value added services and to return a result. In response to the result from the external processing network, or not, as applicable the domestic processing network 106 is configured to then forward the authorization message to the acquirer institution 104, which, in turn, notifies the first party of the disposition.

As necessary, then, the acquirer institution 104 and the issuer institution 108 are configured to cooperate, through the domestic processing network 106, to clear and settle the resulting transaction (generally, in combination with hundreds, thousands, or more other transaction, etc.).

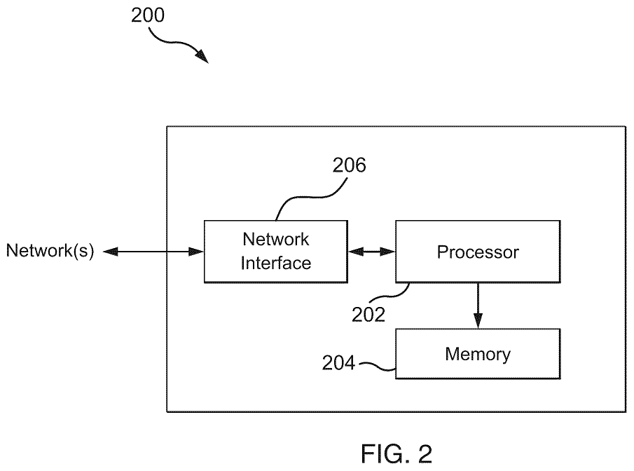

FIG. 2 illustrates an example computing device 200 that can be used in the system 100. The computing device 200 may include, for example, one or more servers, workstations, computers, laptops, etc. In addition, the computing device 200 may include a single computing device, or it may include multiple computing devices located in close proximity or distributed over a geographic region, so long as the computing devices are configured to function as described herein. In the system 100, the external processing network 102, the acquirer institution 104, the domestic processing network 106, the issuer institution 108, the local switch 110, and the value added services 112, each may include, or be implemented in, one or more computing devices generally consistent with the computing device 200. However, the system 100 should not be considered to be limited to the computing device 200, as described below, as different computing devices and/or arrangements of computing devices may be used. In addition, different components and/or arrangements of components may be used in other computing devices.

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a programmable gate array (e.g., a field programmable gate array (FPGA), etc.), a system on chip (SOC), and/or any other circuit or processor capable of the operations described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, account data, domestic regulations, and/or other types of data (and/or data structures) suitable for use as described herein. Furthermore, in various embodiments, computer-executable instructions, i.e., software instructions, may be stored in the memory 204 for execution by the processor 202 to cause the processor 202 to perform one or more of the operations described herein (e.g., of the method 300, etc.), such that the memory 204 is a physical, tangible, and non-transitory computer readable storage media. Such instructions often improve the efficiencies and/or performance of the processor 202 that is performing one or more of the various operations herein, whereby in performing the operations the computing device 200 is transformed into a special purpose computing device. In addition, one or more load files may be stored in memory 204, which include hardware descriptions that, when loaded to the processor 202 (or another processor), cause the processor 202 to be structured consistent with the descriptions herein (e.g., descriptions of gate array arrangements/configurations, etc.).

Further, the illustrated computing device 200 also includes a network interface 206 coupled to (and in communication with) the processor 202 (and/or the memory 204). The network interface 206 may include, without limitation, a wired network adapter, a wireless network adapter, a mobile network adapter, or other device capable of communicating to one or more different networks, for example, as included in the system 100. Further, in some example embodiments, the computing device 200 includes the processor 202 and one or more network interfaces 206 incorporated into or with the processor 202.

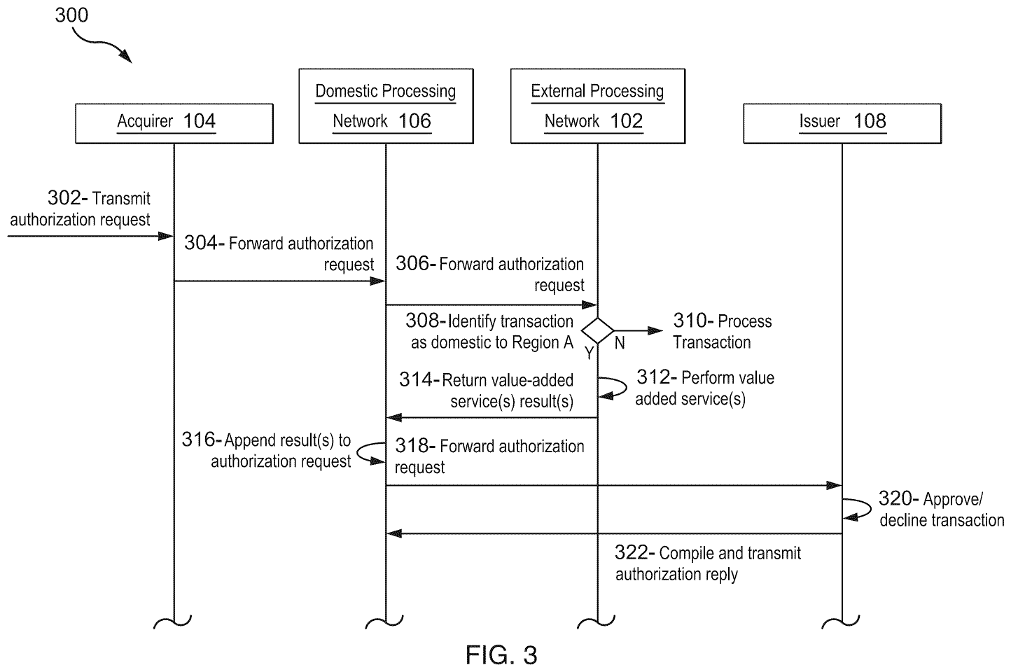

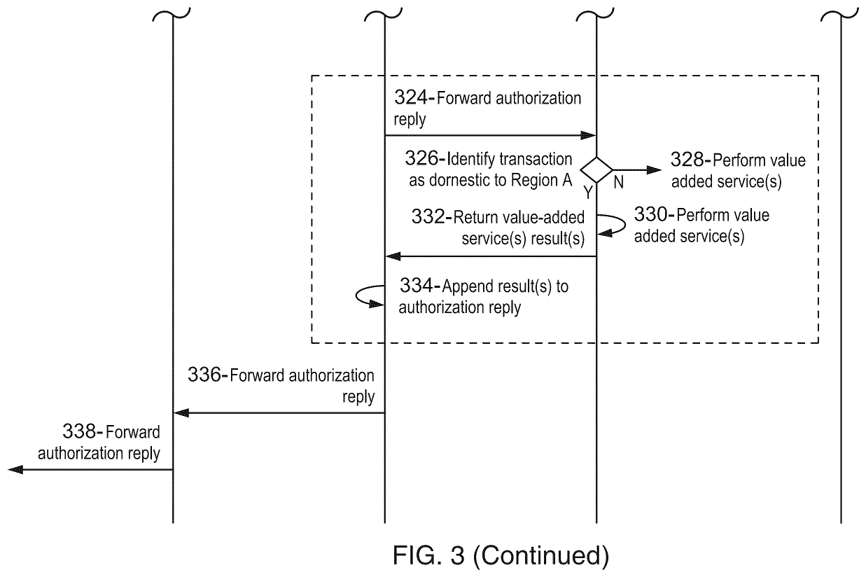

FIG. 3 illustrates an example method 300 for use in integrating one or more value added service(s) associated with network messaging into a domestic processing network. The method 300 is described with reference to the system 100, and further with reference to the computing device 200. While described in connection with the system 100 and the computing device 200, it should also be appreciated that the methods herein are not limited to the system 100 and computing device 200, and that the systems and computing device herein are similarly not limited to the method 300.

At the outset, it should be appreciated that a transaction is initiated at a first party (e.g., a merchant, etc.), which is located in Region A of FIG. 1, whereby the first party initiates a payment account transaction by transmitting, at 302, an authorization message, i.e., an authorization request, to the acquirer institution 104. The authorization message includes the account number of a customer involved in the purchase at the first party, an amount to be paid, a currency of the amount to be paid, a merchant name, a merchant identifier, a merchant category code (MCC), terminal ID, merchant account number, acquirer ID, and/or any other suitable data representative of the transaction.

In response to the authorization request, the acquirer institution 104 identifies the authorization request to the domestic processing network (e.g., based on the account number included in the authorization request (e.g., the BIN, etc.), etc.) and forwards, at 304, the authorization request message to the domestic processing network 106. In turn, the domestic processing network 106 identifies the authorization request as eligible or suitable or required for one or more value added services to be performed by the external processing network 102 (on the “request” leg of authorization of the transaction) (but implements the processing in Region A) (e.g., based on the account number included in the authorization request (e.g., the BIN, etc.), the acquirer identifier (e.g., acquirer ICA, etc.), currency, transaction type, country code, or other data included in the authorization request, or otherwise, etc.) and forwards, at 306, the authorization request to the external processing network 102, via the local switch 110

Upon receipt of the authorization request, the external processing network 102, identifies the transaction as domestic to Region A, or not, at 308. Identifying the transaction as being domestic to Region A is based on multiple of: the account number of the account funding the transaction (e.g., the customer account number, etc.), the location of the local switch 110, an identifier of the acquirer institution 104 (e.g., acquirer ID, a BIN of the account number used to fund the transaction, etc.), the currency of the transaction, and/or the account number of the first party involved in the transaction. Specifically, the account number of the customer is generally indicative of the location of the issuer institution 108, either in Region A or not. In this example, the BIN, specifically, indicates the issuer institution 108 and the issuer's locality in Region A. Similarly, the acquirer ID indicates the acquirer institution 104 and/or the location of the acquirer institution 104 in Region A.

It should be appreciated that other data from the authorization message may be used to identify the transaction as domestic to Region A, or not.

When not identified as domestic to Region A, at 310, the external processing network 102 processes the transaction as is conventional (e.g., transmits the authorization message to the appropriate institution (e.g., to the appropriate issuer institution for approval or decline, etc.).

Conversely, when the transaction is domestic to Region A (i.e., between institutions located in Region A), at 312, the external processing network 102 performs one or more value added services for the transaction (but does not further transmit the authorization message to an issuer institution, etc.). And, at 314, the external processing network 102 returns the value added service result(s) to the domestic processing network 106. Importantly, in the method 300 when identified as domestic, the external processing network 102 does not participate in switching messaging for authorization of the transaction, or in this example, clearing or settling the transaction.

It should be appreciated that while a result is returned in this example, various embodiments may not include a result to return. For example, where the value added service is dispute management, the external processing network 102 may populate, at 312, the relevant information into the dispute management server in performing the value added service. As such, no result (e.g., other than a confirmation or acknowledgement, etc.) is generated, or returned to the domestic processing network 106.

Upon receipt of the result(s) from the external processing network 102, when such a result is returned, the domestic processing network 106 appends, at 316, the result(s) to the authorization message and forwards, at 318, the authorization message to the issuer transmits the authorization message to the appropriate issuer institution 108. In response, the issuer transmits the authorization message to the issuer institution 108, which applies rules and/or logic to either approve or decline the transaction, at 320. The rules and/or logic may take into account one or more of the result(s) of the value added service(s) performed at step 312. For example, the issuer institution 108 may rely on a fraud score generated by the external processing network 102 at 312, and then included in the authorization message by the domestic processing network 106 at 316. It should be appreciated that other results may be included in the authorization message and used otherwise by the issuer institution 108 in either approving or declining the transaction.

Next, at 322, the issuer institution 108 compiles and transmits an authorization message, i.e., an authorization reply, to the domestic processing network 106. The authorization message includes data from the authorization message received from the domestic processing network 106 and also the approval or decline of the transaction.

Optionally, as indicated by the dotted box in FIG. 3, the domestic processing network 106 identifies the authorization reply as eligible or suitable or required for one or more value added services to be performed by the external processing network 102 (on the “reply” leg of authorization of the transaction) (but, again, still effecting processing of the transaction in Region A) (e.g., based on the account number included in the authorization request (e.g., the BIN, etc.), the acquirer identifier (e.g., acquirer ICA, etc.), currency, transaction type, country code, or other data included in the authorization request, or otherwise, etc.) and forwards, at 324, the authorization reply to the external processing network 102, via the local switch 110

Upon receipt of the authorization reply, the external processing network 102, identifies the transaction as domestic to Region A, or not, at 326. Identifying the transaction as being domestic to Region A is based on multiple of: the account number of the account funding the transaction (e.g., the customer account number, etc.), the location of the local switch 110, an identifier of the acquirer institution 104 (e.g., acquirer ID, a BIN of the account number used to fund the transaction, etc.), the currency of the transaction, and/or the account number of the first party involved in the transaction. Specifically, the account number of the customer is generally indicative of the location of the issuer institution 108, either in Region A or not. In this example, the BIN, specifically, indicates the issuer institution 108 and the issuer's locality in Region A. Similarly, the acquirer ID indicates the acquirer institution 104 and/or the location of the acquirer institution 104 in Region A.

It should be appreciated that other data from the authorization reply may be used to identify the transaction as domestic to Region A, or not.

When not identified as domestic to Region A, at 328, the external processing network 102 performs any desired value added services and then processes the transaction as is conventional (e.g., transmits the authorization reply to the appropriate institution (e.g., to the appropriate acquirer institution which then forwards the authorization reply to the first party, etc.), etc.).

Conversely, when the transaction is domestic to Region A (i.e., between institutions located in Region A), at 330, the external processing network 102 performs one or more value added services for the transaction (but does not further transmit the authorization message to an acquirer institution, etc.). And, at 332, the external processing network 102 returns the value added service result(s) to the domestic processing network 106. Importantly, in the method 300 when identified as domestic, the external processing network 102 does not participate in switching messaging for authorization of the transaction, or in this example, clearing or settling the transaction.

It should be appreciated that while a result is returned in this example, various embodiments may not include a result to return. For example, where the value added service is dispute management, the external processing network 102 may populate, at 330, the relevant information into the dispute management server in performing the value added service. As such, no result (e.g., other than a confirmation or acknowledgement, etc.) may be generated, or returned to the domestic processing network 106.

Upon receipt of the result(s) from the external processing network 102, when such a result is returned, the domestic processing network 106 appends, at 334, the result(s) to the authorization message.

Next, at 336, the domestic processing network 106 forwards the authorization message to the acquirer institution 104, and at 338, the acquirer institution 104 forwards the authorization reply to the first party.

It should be appreciated that the value added service(s) may be performed by the external processing network 102 in an authorization request leg of the transaction, and also potentially, in the authorization reply leg of the transaction, as shown in FIG. 3. Alternatively, the value added service(s) may be applied, by the external processing network 102, in the authorization reply leg of the transaction, but not in the authorization request leg of the transaction. Also, the values added service(s) may optionally be performed by the external processing network 102 in either or both of the clearing and/or settling of the transaction.

In view of the above, the systems and method herein provide for efficient integration of out-of-region value added services to domestic, in-region transactions, while conforming and/or complying with domestic rules and/or regulations related to data in the region. As such, advanced value added service(s), which are offered by the external processing network, are made available to domestic transactions in the region without requiring physical presence of the external processing network or the value added service(s) in the domestic region. This again is a technical advancement of the processing networks, while the same is generally transparent to involved institutions, i.e., the acquirers, issuers, etc., which are not required to take additional steps (e.g., apart from updated routing tables, etc.) to expose the transactions to the advanced value added services.

Again, and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code and/or load files (prior to implementation in hardware) in the form of instructions or data structures and that can be accessed by a processor, and/or implemented in hardware. Combinations of the above should also be included within the scope of computer-readable media.

It should also be appreciated that one or more aspects of the present disclosure transforms a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing one or more of: (a) receiving, from a domestic processing network, an authorization message for a transaction to an account, the authorization message including a first identifier associated with a first institution, a second identifier associated with a second institution, and a switch identifier; (b) identifying the transaction as a domestic transaction in a first region, based on the first identifier, the second identifier and/or the switch identifier included in the authorization message; (c) performing at least one value added service for the transaction, without seeking authorization of the transaction; and/or (d) returning a result of the at least one value added service to the domestic processing network.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in integrating one or more value added service(s) associated with network messaging into a domestic processing network, the method comprising:
receiving, by a computing device, from a domestic processing network, an authorization message for a transaction to an account, the authorization message including a first identifier associated with a first institution, a second identifier associated with a second institution, and a switch identifier;
identifying, by the computing device, the transaction as a domestic transaction in a first region, based on the first identifier, the second identifier and/or the switch identifier included in the authorization message;
performing, by the computing device, at least one value added service for the transaction, without seeking authorization of the transaction; and
returning, by the computing device, a result of the at least one value added service to the domestic processing network.

2. The computer-implemented method of claim 1, wherein the first institution is an acquirer bank located in the first region, and wherein the first identifier is an acquirer identifier for the acquirer bank;
wherein the second institution is an issuer bank located in the first region, which issued the account; and/or
wherein the second identifier includes a part of an account number for the account.

3. The computer-implemented method of claim 1, wherein the authorization message includes a currency of the transaction; and
wherein identifying the transaction as the domestic transaction in the first region is further based on the currency of the transaction.

4. The computer-implemented method of claim 1, wherein the at least one value added service includes one or more of fraud scoring, dispute management, loyalty, and/or analytics; and/or
wherein the result includes a fraud score and/or an acknowledgement of entry of the transaction in the dispute management.

5. The computer-implemented method of claim 1, wherein the computing device is part of an external processing network, which is located outside of the first region.

6. The computer-implemented method of claim 5, further comprising:
receiving, by the domestic processing network, the authorization message from the first institution; and
forwarding, by the domestic processing network, the authorization message to the computing device of the external processing network, via a local switch, which is associated with the external processing network and located in the first region;
wherein the switch identifier is specific to said switch, whereby the switch identifier is appended to the authorization message.

7. The computer-implemented method of claim 1, wherein the authorization message is one of an authorization request message and an authorization reply message.

8. A non-transitory computer-readable storage medium including executable instructions for integrating one or more value added service(s) associated with network messaging into a domestic processing network, which when executed by at least one processor, cause the at least one processor to:
receive, from a domestic processing network, an authorization message for a transaction to an account, the authorization message including a first identifier associated with a first institution, a second identifier associated with a second institution, and a switch identifier;
identify the transaction as a domestic transaction in a first region, based on the first identifier, the second identifier and/or the switch identifier included in the authorization message;
perform at least one value added service for the transaction, without seeking authorization of the transaction; and
return a result of the at least one value added service to the domestic processing network.

9. The non-transitory computer-readable storage medium of claim 8, wherein the authorization message includes a currency of the transaction; and
wherein the executable instructions, when executed by the at least one processor to identify the transaction as the domestic transaction in the first region, cause the at least one processor to identity the transaction as the domestic transaction in the first region further based on the currency of the transaction.

10. The non-transitory computer-readable storage medium of claim 9, wherein the at least one value added service includes one or more of fraud scoring, dispute management, loyalty, and/or analytics; and/or
wherein the result includes a fraud score and/or an acknowledgement of entry of the transaction in the dispute management.

11. The non-transitory computer-readable storage medium of claim 9, wherein the at least one processor is part of an external processing network, which is located outside of the first region.

12. The non-transitory computer-readable storage medium of claim 11, wherein the first institution is an acquirer bank located in the first region, and wherein the first identifier is an acquirer identifier for the acquirer bank;
wherein the second institution is an issuer bank located in the first region, which issued the account; and/or
wherein the second identifier includes a part of an account number for the account.

13. The non-transitory computer-readable storage medium of claim 12, wherein the authorization message is one of an authorization request message and an authorization reply message.

14. An external processing network for integrating one or more value added service(s) associated with network messaging into a domestic processing network, the external processing network comprising at least one computing device configured to:
receive, from the domestic processing network, an authorization message for a transaction to an account, the authorization message including a first identifier associated with a first institution, a second identifier associated with a second institution, and a switch identifier;
identify the transaction as a domestic transaction in a first region, based on the first identifier, the second identifier and/or the switch identifier included in the authorization message;
perform at least one value added service for the transaction, without seeking authorization of the transaction; and
return a result of the at least one value added service to the domestic processing network.

15. The external processing network of claim 14, wherein the authorization message includes a currency of the transaction; and
wherein the at least one computing device is configured, in order to identify the transaction as the domestic transaction in the first region, to identify the transaction as the domestic transaction in the first region further based on the currency of the transaction.

16. The external processing network of claim 14, wherein the first institution is an acquirer bank located in the first region, and wherein the first identifier is an acquirer identifier for the acquirer bank;
wherein the second institution is an issuer bank located in the first region, which issued the account; and/or
wherein the second identifier includes a part of an account number for the account.

17. The external processing network of claim 16, wherein the authorization message is one of an authorization request message and an authorization reply message.

18. The external processing network of claim 14, further comprising a local switch disposed in the first region, wherein the local switch is configured to direct the authorization message from the domestic processing network to the at least one computing device; and
wherein the switch identifier is specific to said local switch, whereby the switch identifier is appended to the authorization message.

19. The external processing network of claim 18, wherein the location switch is disposed at the domestic processing network.
